(19) United States
(12) Patent Application Publication
(10) Pub. No.: US 2010/0089338 A1
(43) Pub. Date: Apr. 15, 2010

(54) Child safety tether

(76) Inventor: Gina Stern, Harrington Park, NJ (US)

Correspondence Address: Gina Stern, 290 Harriot Ave, Harrington Park, NJ, 07640, US

(21) Appl. No.: 12/287,738

(22) Filed: Oct. 15, 2008

(51) Int. Cl. A62B 35/00

(52) U.S. Cl. 119/770

(57) ABSTRACT

Child safety tether with a care giver vest, a child vest, a care giver tether attachment member, a child tether attachment member, a care giver tether attachment member track, a child tether attachment member track, a tether, a tether spring reel, a plurality of track to vest attachment members and a track attachment buckle. Each tether track is fixed to each vest. The tether spring reel is attached to the care giver tether attachment member. The care giver tether attachment member is slidably fixed within the care giver tether attachment track. The tether is attached at one end to the spring reel and at the other end to the child slidable tether attachment member so that when either the child or the care giver turns or rotates in place, the tether attachment members will slide within the tether attachment member tracks thereby reducing the possibility of tether entanglement.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of child safety devices and more specifically to a child safety tether.

It is a common problem when raising children that at a young age the child is old enough to walk but not old enough to be fully aware of the dangers of not staying on the sidewalk or of wandering too far from a care giver and possibly getting lost. To solve this problem the idea of a harness that attaches to the child and a tether that attaches to the harness has been developed in a similar fashion to that of a pet harness and leash.

However there are several deficiencies in the prior technology. First, many care givers do not like the association that can be made when seeing a child in a harness and on a leash. The appearance is too much like that of walking a pet dog rather than walking with a human child. Secondly, active children tend to run around their care giver and can cause a tether to become wrapped around the care giver's legs or the child's own legs or body. This condition can cause either the care giver or the child to be restricted in such a way that they might fall and become injured. Finally, a care giver may be carrying additional items such as a purse or a package and not have the extra hand needed to hold onto the end of a tether.

### BRIEF SUMMARY OF THE INVENTION

The primary object of the invention is to provide a child safety tether that connects a care giver with a child in a way that reduces the chance of the care giver or the child to become entangled in the tether. Another object of the invention is to provide a care giver to child tether system that has a stylish appearance and not the appearance of a leash and harness that is normally associated with a pet dog. Another object of the invention is to provide a care giver to child tether system that allows the care giver to have his or her hands free for other tasks besides holding onto the tether.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed child safety tether comprising: a care giver vest, a child vest, a care giver slidable tether attachment member, a child slidable tether attachment member, a care giver tether attachment member track, a child tether attachment member track, a tether, a tether spring reel, a plurality of track to vest attachment members, a track attachment buckle, said tether attachment track fixed to the lower portion of said vest by said track attachment members, said tether spring reel attached to said care giver tether attachment member, said care giver tether attachment member slidably fixed within said care giver tether attachment member track, said tether attached at one end to said spring reel, and said tether terminating at the opposite end in said child slidable tether attachment member so that when either said child or said care giver turns or rotates in place, said tether attachment members slide within said tether attachment member tracks thereby reducing the chance of said tether to wrap around and restrict the movement of said care giver or said child.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a front view of the child's vest and tether track assembly.

FIG. 3 is a top view of the child's vest and tether track assembly in the closed position.

FIG. 4 is a top view of the child's vest and tether track assembly in the open position.

FIG. 5 is a section view of the tether attachment member and attachment member track.

FIG. 6 is a perspective view of the track attachment buckle.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

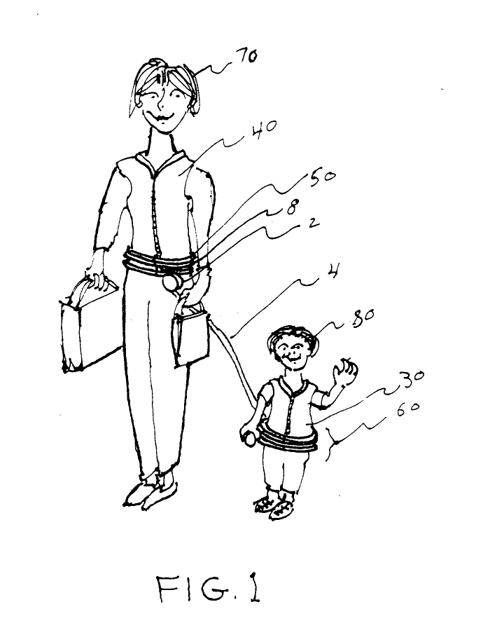

Referring now to FIG. 1 we see a perspective view of the invention where a care giver 70 is wearing a vest 40 that has a tether attachment member track 50 fixed to the bottom portion of the vest 40. A child 80 is wearing a similar but smaller vest 30 with a similar but smaller diameter tether attachment member track 60 fixed to the bottom portion of the vest 30. A tether attachment member 8 is slidably positioned within the track 50 and a standard spring reel assembly 2 holds a retractable and extendable tether 4 which terminates at its opposite end in a similar tether attachment member 8 which is slidably positioned within track 60 on the child's vest. The resulting configuration allows the tether 4 to slide around either track 50 or 60 so that if the child or care giver turn or rotate in place, the tether is less likely to be wound around the child or care giver's legs. Additionally, the care giver's hands do not have to hold onto the tether so that they remain free to hold other items such as a shopping bag or purse. The spring reel assembly includes a locking mechanism that can lock the tether to the desired length. The stylish matched pair of vests creates a more acceptable appearance than that of a traditional leash and harness assembly used to walk a pet dog.

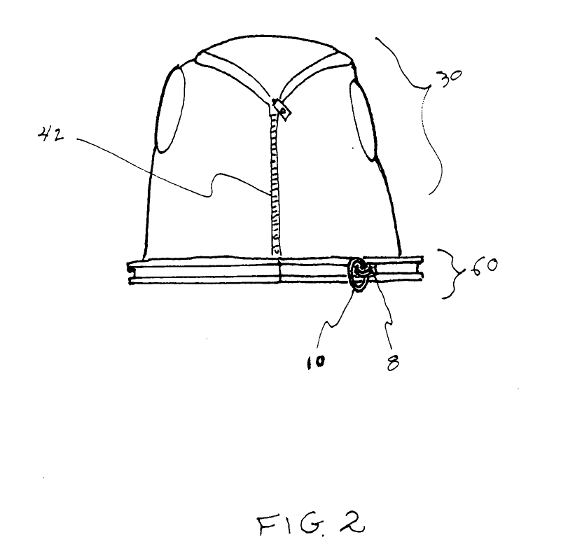

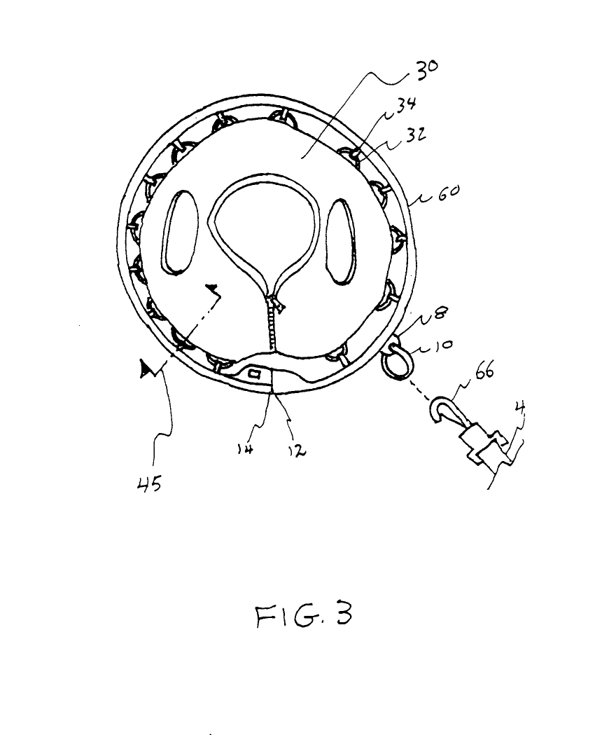

FIG. 2 is a front view of the child's vest 30 with the track 60 attached. For purposes of discussion of vest construction, I will be referring to the child's vest only. It should be noted that the care giver's vest is of similar construction but larger in physical size. The track 50. 60 dimensions are similar except the care giver's track is larger in diameter. The vest 30 is a simple standard construction with a standard front closure such as a zipper 42. This view shows the slidable tether attachment member 8 and an attachment ring 10. A standard hook 66, shown in FIG. 3, snaps onto ring 10. The tether 4 is fixedly attached to hook 66. The track 60 is made of flexible molded plastic such as high density polyethylene. The sliding attachment members 8 are also molded of plastic that has a high slip factor such as polyethylene or teflon so that they can easily slide around tracks 50 and 60.

FIG. 3 shows a top view of the vest 30 in the closed position. track tabs 34 are fixed at regular intervals along the inside diameter of track 60. Each track tab 34 has an aperture that can accept a cord or other standard attachment means which can be fixed to the vest on either side of the tab 34. In this way, the track can retain its essentially circular or elliptical shape regardless of the actual shape of the bottom portion of the vest 30. The track is shown continuous but can be separated at buckle location 12, 14.

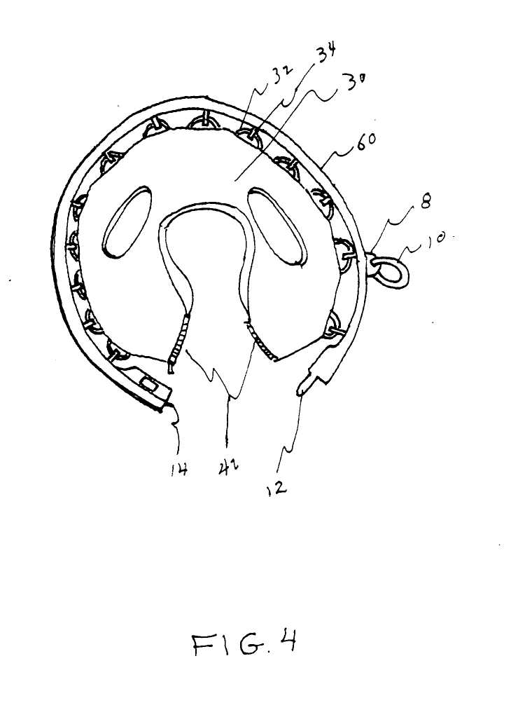

FIG. 4 shows a top view of the vest 30 in the open position. Buckle portions 12, 14 can be see in their disconnected embodiment, and with vest zipper 42 in its unzipped and open embodiment. This allows the user to easily put on the vest and then buckle the track ends 12, 14 and zip up the zipper 42.

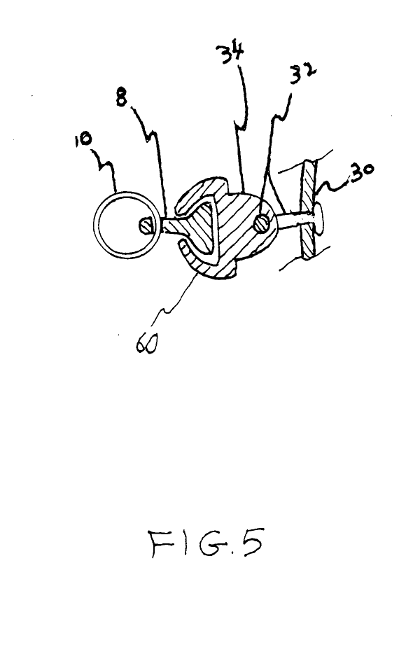

FIG. 5 shows a side section view, as defined by section line 45 in FIG. 3, of the track 60 and slide member 8. Attached tab 34 secures the ring 60 to the vest 30 by cord 32. Ring 10 removably retains tether attachment hook 66 as previously described. The design and dimensions of slide member 8 allow for easy sliding within track 60.

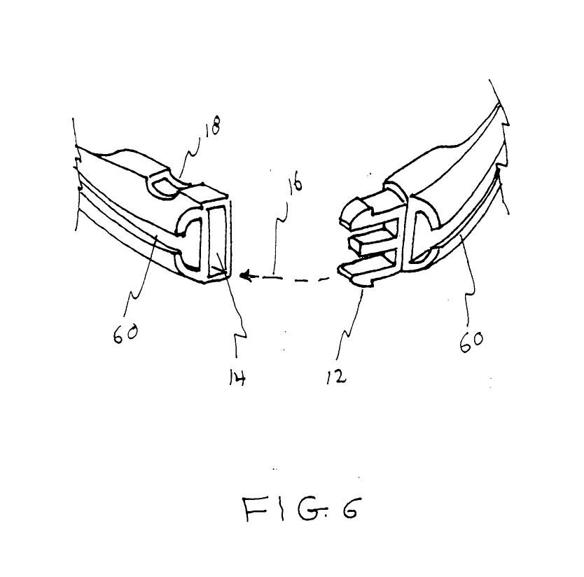

FIG. 6 shows a perspective view of the track attachment portion 12, 14 where the flexible fingers of a standard snap buckle 12 can releasably engage the mating socket 14 so that the fingers snap into retaining apertures 18. When the two halves 12, 14 are snapped together, the track portions 60 abut each other so that sliding member 8 can continue in an uninterrupted manner around the track 60, 50 during use.

In the above described and illustrated way, the present novel child restraining tether invention increases safety for a child and also allows a child or care giver to turn or rotate without the danger of becoming entangled in the tether. The overall design is stylish and does not evoke the image of a pet on a leash. The invention allows the care giver hands free freedom so that he or she may carry other items rather than hold onto a tether.

While the invention has been described in connection with a preferred embodiment, it is not intended to limit the scope of the invention to the particular form set forth, but on the contrary, it is intended to cover such a alternatives, modifications, and equivalents as may be included within the spirit and scope of the invention as defined by the appended claims.

What is claimed is:

1. child safety tether comprising:
a care giver vest;
a child vest;
a care giver slidable tether attachment member;
a child slidable tether attachment member;
a care giver tether attachment member track;
a child tether attachment member track;
a tether;
a tether spring reel;
a plurality of track to vest attachment members;
a track attachment buckle;
said tether attachment track fixed to the lower portion of said vest by said track attachment members;
said tether spring reel attached to said care giver tether attachment member;
said care giver tether attachment member slidably fixed within said care giver tether attachment member track;
said tether attached at one end to said spring reel; and
said tether terminating at the opposite end in said child slidable tether attachment member so that when either said child or said care giver turns or rotates in place, said tether attachment members will slide within said tether attachment member tracks thereby reducing the chance of said tether to wrap around and restrict the movement of said care giver or said child.
